(19) United States
(12) Patent Application Publication
(10) Pub. No.: US 2014/0159689 A1
(43) Pub. Date: Jun. 12, 2014

(54) CONSTANT TIME CONTROL METHOD, CONTROL CIRCUIT AND SWITCH REGULATOR USING THE SAME

(71) Applicant: Silergy Semiconductor Technology (Hangzhou) LTD, Hangzhou (CN)

(72) Inventor: Wei Chen, Saratoga, CA (US)

(73) Assignee: Silergy Semiconductor Technology (Hangzhou) LTD, Hangzhou (CN)

(21) Appl. No.: 14/095,045

(22) Filed: Dec. 3, 2013

(30) Foreign Application Priority Data
Dec. 11, 2012 (CN) 201210538585.3

(51) Int. Cl. H02M 3/156

(52) U.S. Cl. CPC H02M 3/156
USPC 323/282

(57) ABSTRACT

In one embodiment, a method of controlling a switching regulator can include: obtaining a voltage feedback signal by detecting an output voltage; generating a triangle wave signal by detecting a current flowing through an inductor; generating a first control signal by superimposing the triangle wave signal and the voltage feedback signal; calculating an error between the voltage feedback signal and a first reference voltage, and compensating for the error to obtain a compensation signal; generating a second control signal by comparing the first control signal against the compensation signal; and controlling switching of a power switch in the switching regulator based on the second control signal and a constant time control signal, where an output signal of the switching regulator is maintained as substantially constant.

### RELATED APPLICATIONS

This application claims the benefit of Chinese Patent Application No. 201210538585.3, filed on Dec. 11, 2012, which is incorporated herein by reference in its entirety.

### FIELD OF THE INVENTION

The present invention relates to power supply technology, and more particularly to a constant time control approach applied in a switching regulator, and a constant time control circuit.

### BACKGROUND

A switched-mode power supply (SMPS), or a “switching” power supply, can include a power stage circuit and a control circuit. When there is an input voltage, the control circuit can consider internal parameters and external load changes, and may regulate the on/off times of the switch system in the power stage circuit. In this way, the output voltage and/or the output current of the switching power supply can be maintained as substantially constant. Therefore, the selection and design of the particular control circuitry and approach is very important to the overall performance of the switching power supply. Thus, using different detection signals and/or control circuits can result in different control effects on power supply performance.

### SUMMARY

In one embodiment, a method of controlling a switching regulator can include: (i) obtaining a voltage feedback signal by detecting an output voltage of the switching regulator; (ii) generating a triangle wave signal by detecting a current flowing through an inductor of the switching regulator; (iii) generating a first control signal by superimposing the triangle wave signal and the voltage feedback signal; (iv) calculating an error between the voltage feedback signal and a first reference voltage, and compensating for the error to obtain a compensation signal, where the compensation signal is maintained as substantially constant; (v) generating a second control signal by comparing the first control signal against the compensation signal; (vi) controlling switching of a power switch in the switching regulator based on the second control signal and a constant time control signal, where an output signal of the switching regulator is maintained as substantially constant; and (vii) controlling the inductor current to follow an output current of the switching regulator in response to a step change in the output current, where an average value of the inductor current is restored after the step change to be consistent with the output current to reduce ripples in the output voltage.

In one embodiment, a constant time control circuit can include: (i) a triangle wave signal generating circuit configured to generate a triangle signal that indicates a current flowing through an inductor of a switching regulator; (ii) a first control signal generating circuit configured to generate a first control signal by superimposing the triangle wave signal and a voltage feedback signal that indicates an output voltage of the switching regulator; (iii) a compensation signal generating circuit configured to generate a substantially constant compensation signal to compensate for an error between the voltage feedback signal and a first reference voltage; (iv) a comparing circuit configured to compare the compensation signal and the first control signal, and to generate a second control signal; (v) a logic circuit configured to generate a third control signal based on the second control signal and a constant time control signal, where during each switch cycle of the switching regulator, the third control signal is configured to control an on time or off time of a power switch as a constant time; and (vi) the inductor current being controlled to follow an output current of the switching regulator in response to a step change in the output current, where an average value of the inductor current is restored after the step change to be consistent with the output current to reduce ripples in the output voltage.

Embodiments of the present invention can provide several advantages over conventional approaches, as may become readily apparent from the detailed description of preferred embodiments below.

### BRIEF DESCRIPTION OF THE DRAWINGS

FIG. 1A is a schematic block diagram of an example DC-DC converter controlled by a constant on time valley value current control.

FIG. 1B is a waveform diagram showing example operation of the DC-DC converter shown in FIG. 1A.

FIG. 2A is a schematic block diagram of an example time control circuit for controlling a switching regulator in accordance with embodiments of the present invention.

FIG. 2B is a waveform diagram showing example operation in a first mode of the constant time control circuit shown in FIG. 2A.

FIG. 2C is a waveform diagram showing example operation in a second mode of the constant time control circuit shown in FIG. 2A.

FIG. 3A is a schematic block diagram of a first example triangle wave signal generating circuit in accordance with embodiments of the present invention.

FIG. 3B is a schematic block diagram of a second example triangle wave signal generating circuit in accordance with embodiments of the present invention.

FIG. 3C is a schematic block diagram of a third triangle wave signal generating circuit in accordance with embodiments of the present invention.

FIG. 3D is a schematic block diagram of a fourth example triangle wave signal generating circuit in accordance with embodiments of the present invention.

FIG. 3E is a schematic block diagram of an example AC ripple amplifier of the triangle wave signal generating circuit shown in FIG. 3D.

FIG. 4 is a schematic block diagram of another example constant time control circuit for controlling a switching regulator in accordance with embodiments of the present invention.

FIG. 5 is a schematic block diagram of another example constant time control circuit for controlling a switching regulator in accordance with embodiments of the present invention.

FIG. 6A is a schematic block diagram of an example constant time generating circuit in the constant time control circuit shown in FIG. 2A.

FIG. 6B is a waveform diagram showing example operation of the constant time control circuit of the constant time generating circuit shown in FIG. 6A.

FIG. 7A is a schematic block diagram of yet another example constant time control circuit for controlling a switching regulator in accordance with embodiments of the present invention.

FIG. 7B is a waveform diagram showing example operation of the constant time control circuit shown in FIG. 7A.

FIG. 8 is a flow diagram of an example constant time control method in accordance with embodiments of the present invention.

### DETAILED DESCRIPTION

Reference may now be made in detail to particular embodiments of the invention, examples of which are illustrated in the accompanying drawings. While the invention may be described in conjunction with the preferred embodiments, it may be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it may be readily apparent to one skilled in the art that the present invention may be practiced without these specific details. In other instances, well-known methods, procedures, processes, components, structures, and circuits have not been described in detail so as not to unnecessarily obscure aspects of the present invention.

A switched-mode power supply (SMPS), or “switching” power supply is an electronic power supply that incorporates a switching regulator to efficiently convert electrical power. An SMPS transfers power from a source to a load (e.g., a personal computer, smart phone, etc.), while converting voltage and/or current characteristics. Unlike a linear type of power supply, the pass transistor or main switch of a switching supply can continually switch between on and off states in order to minimize wasted energy. Ideally, a switched-mode power supply may dissipate no power. Voltage regulation can be achieved by varying the ratio of on-to-off time of the main switch. This higher power conversion efficiency is an important advantage of a switched-mode power supply, as compared to linear regulators. Switched-mode or switching power supplies may also be substantially smaller and lighter than a linear supply due to smaller transformer size and weight.

Control methods utilised in switching power supplies can generally be divided into fixed-frequency control and varied-frequency control. Fixed-frequency control involves keeping the switch cycle unchanged, and the output voltage can be regulated by regulating the time width in which the switch is turned on within a given cycle by way of pulse-width modulation (PWM).

Varied-frequency control can be subdivided into constant on time, constant off time, and delayed comparing control. Constant on time control involves keeping the on time of the main power switch substantially constant, and regulating the duty cycle by changing the off time of the main power switch. Constant off time control involves keeping the off time of the main power switch substantially constant, and regulating the duty cycle by changing the on time of the main power switch. In practical applications, the constant time control solution is relatively simple and has lower costs and improved stability relative to fixed-frequency control. However, constant time control solutions may respond relatively slow to transient events (a transient state) of the load that may occur during the constant time interval.

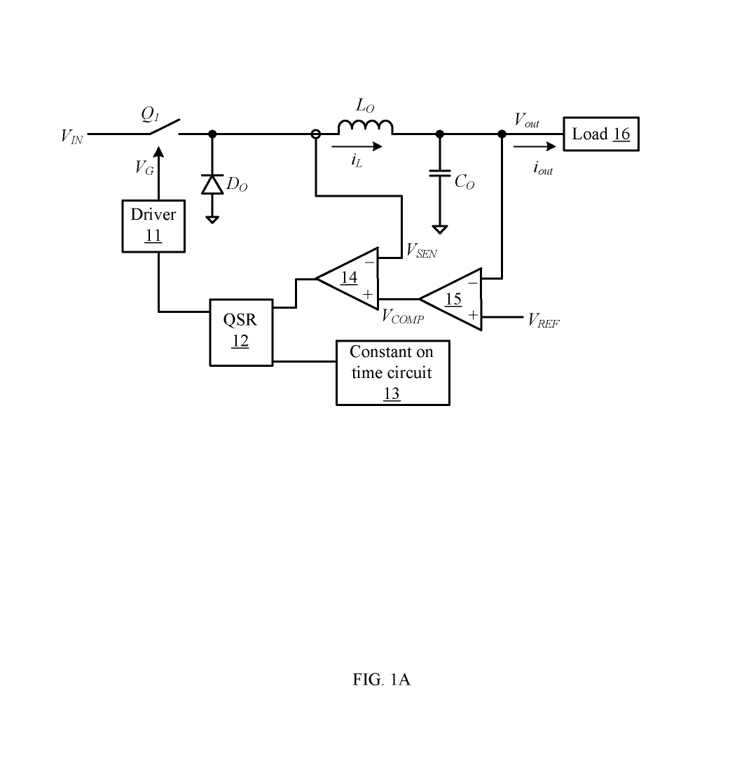

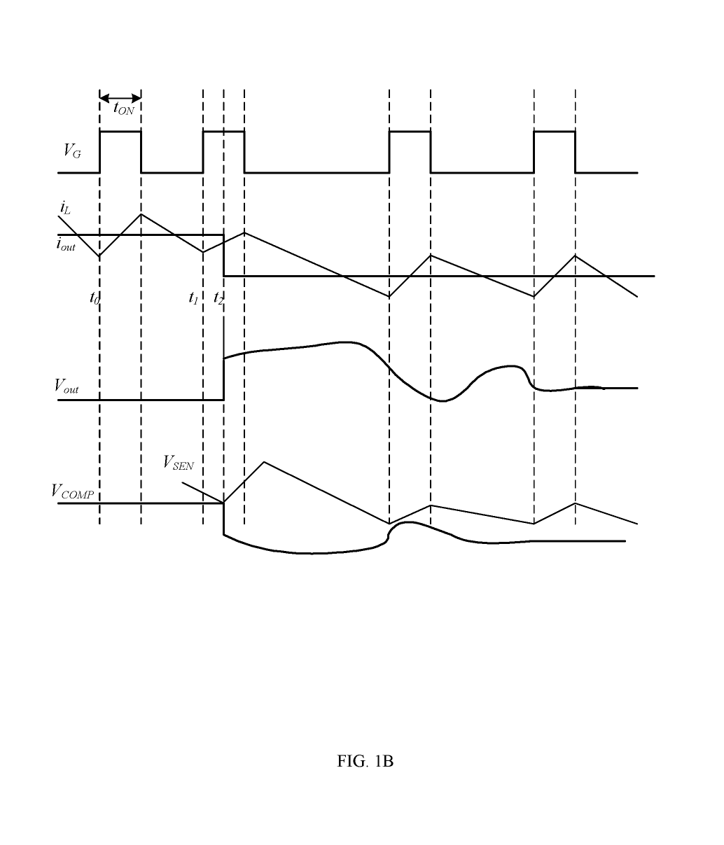

Referring now to FIG. 1A, shown is an example DC-DC converter using a constant on time valley value current control mode. In this example, switch device Q₁, diode D₀, inductor L₀, and output capacitor C₀ can form a buck topology. Input voltage Vᵢₙ can be received, and the converter output can connect to load 16. In operation, the output voltage Vₒᵤₜ and/or output current Iₒᵤₜ can be maintained as substantially constant.

The following will describe example operation of the DC-DC converter by viewing the waveform diagrams showing example operation of the DC-DC converter, of FIG. 1B. For example, within the time period from t₀ to t₁, when the DC-DC converter is in a normal operating state, calculation amplifier 15 can generate a voltage compensation signal V_{COMP} according to reference voltage V_{REF} and sampled output voltage Vₒᵤₜ. Current comparator 14 can compare voltage signal V_{SEN} indicating or denoting the inductor current against voltage compensation signal V_{COMP}, to form a dual-loop control system formed by a current loop and a voltage loop.

When the “valley” or minimum (e.g., a local minimum) current of the inductor current i_{L} reaches a level of voltage compensation signal V_{COMP}, the set terminal of RS flip-flop (QSR) 12 can be activated, and the control signal output by output terminal Q can be provided to driver 11 for driving switch device Q1. After the constant on time circuit 13 determines constant time t_{ON}, the reset terminal of the RS flip-flop can be activated so as to turn off switch device Q1. This operation can be repeated to maintain output voltage Vₒᵤₜ and/or output current iₒᵤₜ as substantially constant based on a constant on time control.

In this implementation, amplifier 15 may be utilized for compensating the output voltage loop. An optimized compensation network needs at least a pair of zero poles and an integrator to ensure system stability and rapid response speed. However, for this kind of compensation design, the compensation design parameter may depend on various circuit parameters (e.g., output capacitance), as well as actual use conditions (e.g., output current). Because such circuit parameters and use conditions in actual usage may substantially vary, a fixed optimized compensation design may not be suitable for a switch power supply system.

In addition, within the constant on time, load 16 may have a step change or mutation (e.g., from a heavy-load to a light-load). For example, at time t₂ in FIG. 1B, output current iₒᵤₜ may instantly reduce in a step or near step type of change. At this time, due to the control of the constant time control circuit, switch device Q₁ may be in an on state, and thus inductor current i_{L} can continue to increase until the current on time t_{ON} ends. It can be seen that such a control solution can make the difference between the inductor current i_{L} and output current iₒᵤₜ increasingly large. Moreover, output voltage Vₒᵤₜ can rise instantly at time t₂, and during the on time, the output voltage can continuously rise. Thus, the ripple of the output voltage is relatively large, potentially requiring a relatively long time to again reach a new stable status, and to output a substantially constant output voltage to the load.

It can be seen that by using the DC-DC converter of the constant time control solution shown in FIG. 1A, the compensation design of the system is relatively complex, and the circuit responds slowly to transient changes of the load. This can result in generation of overcharge of the output voltage, as well as potential damage to components and parts in the circuit.

In one embodiment, a constant time control circuit can include: (i) a triangle wave signal generating circuit configured to generate a triangle signal that indicates a current flowing through an inductor of a switching regulator; (ii) a first control signal generating circuit configured to generate a first control signal by superimposing the triangle wave signal and a voltage feedback signal that indicates an output voltage of the switching regulator; (iii) a compensation signal generating circuit configured to generate a substantially constant compensation signal to compensate for an error between the voltage feedback signal and a first reference voltage; (iv) a comparing circuit configured to compare the compensation signal and the first control signal, and to generate a second control signal; (v) a logic circuit configured to generate a third control signal based on the second control signal and a constant time control signal, where during each switch cycle of the switching regulator, the third control signal is configured to control an on time or off time of a power switch as a constant time; and (vi) the inductor current being controlled to follow an output current of the switching regulator in response to a step change in the output current, where an average value of the inductor current is restored after the step change to be consistent with the output current to reduce ripples in the output voltage.

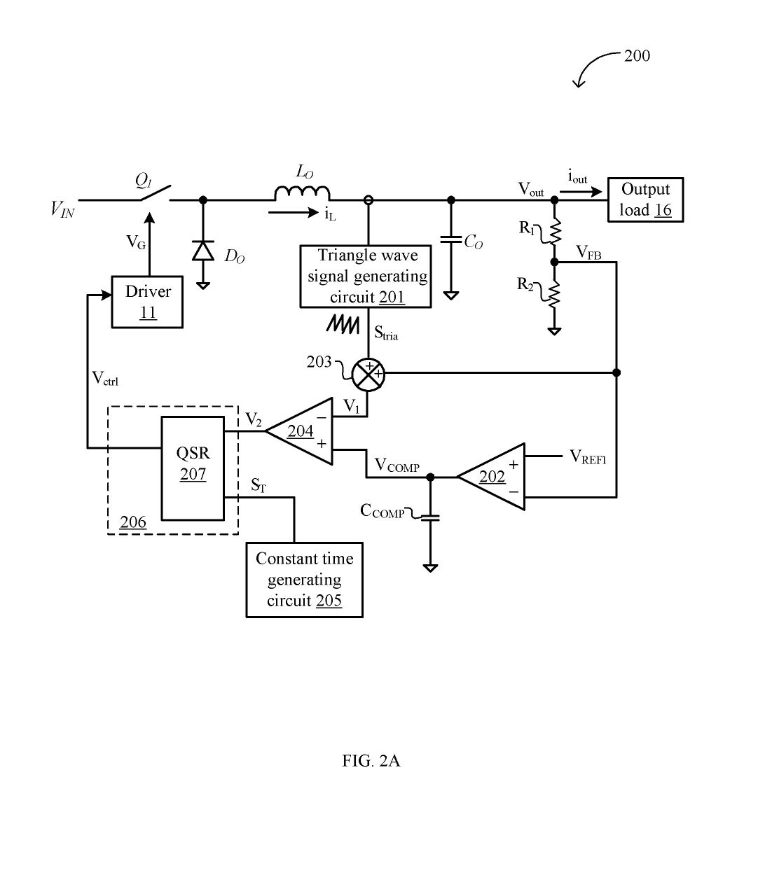

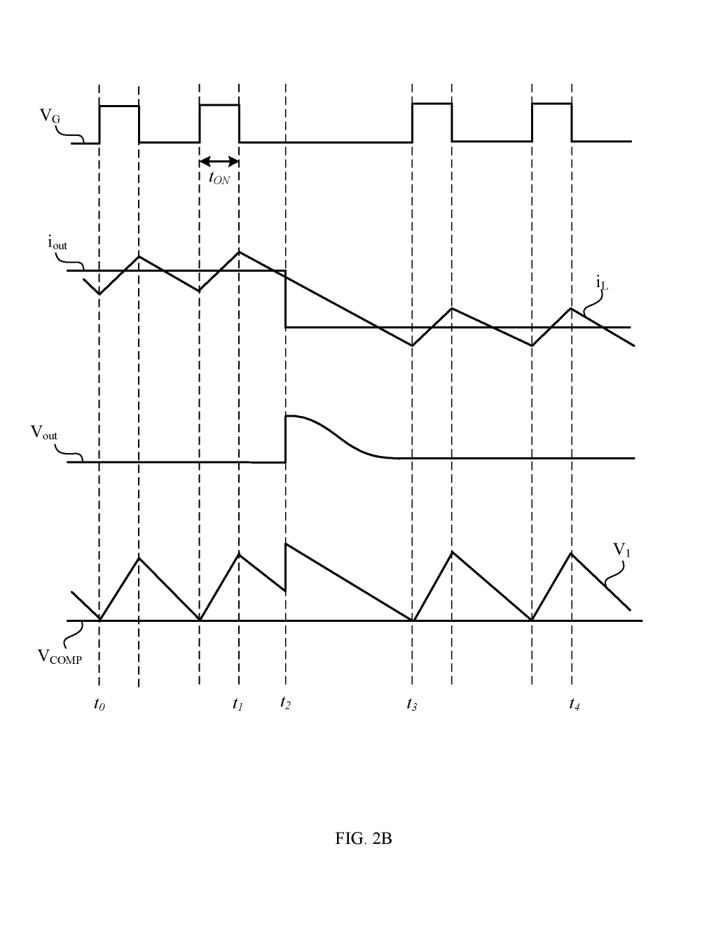

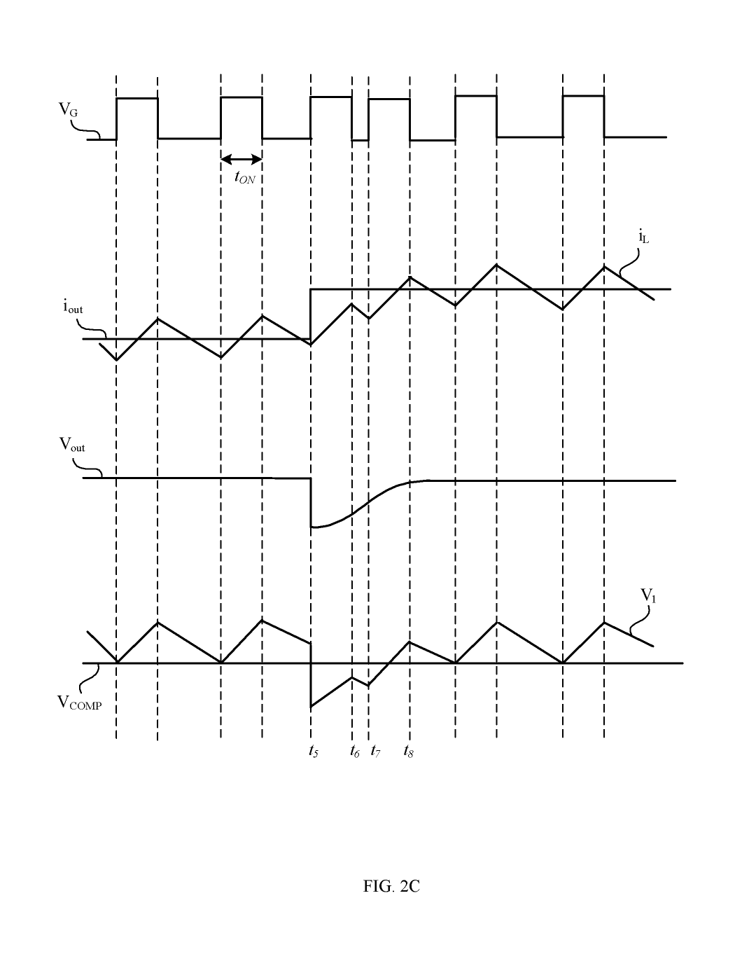

Referring now to FIG. 2A, shown is a schematic block diagram of an example constant time control circuit for controlling a switching regulator in accordance with embodiments of the present invention. This particular example constant time control circuit 200 can be applied in a buck-mode switching regulator. Here, main power switch device Q₁, diode D₀, inductor L₀, and output capacitor C₀ can form a buck-type topology power stage circuit that receives input voltage Vᵢₙ and provides output voltage and/or current to load 16.

Resistor R₁ and resistor R₂ can connect in series between output voltage Vₒᵤₜ to form a voltage-dividing feedback circuit that receives output voltage Vₒᵤₜ such that voltage feedback signal V_{FB} indicates output voltage information. Triangle wave signal generating circuit 201 can generate triangle wave signal Sₜᵣᵢₐ indicating inductor current information based on inductor current i_{L} flowing through inductor L₀. Here, triangle wave signal generating circuit 201 may be realized by any suitable circuitry to accurately generate a triangle wave signal. Triangle wave signal Sₜᵣᵢₐ and voltage feedback signal V_{FB} may be superimposed via a control signal generating circuit (e.g., summing circuit 203), so as to generate control signal V₁.

A compensation signal generating circuit can include error amplifier 202 that can receive voltage feedback signal V_{FB} denoting the output voltage and reference voltage V_{REF1}, and may generate compensation signal V_{COMP} that indicates an error between the current output voltage Vₒᵤₜ and the expected output voltage. Here, error amplifier 202 can be a circuit with a low bandwidth, and its in-phase input can receive reference voltage V_{REF1}, and its inverted input can receive voltage feedback signal V_{FB}. Thus in a steady operating state, the steady state error of the switching regulator can be zero. In this example, the compensation circuit can be relatively simple, and may include capacitor C_{COMP} connected between the output of error amplifier 202 and ground. In this way, compensation signal V_{COMP} can be maintained as substantially constant.

A comparison circuit can include comparator 204 that compares control signal V₁ against compensation signal V_{COMP}, and generates control signal V₂. Logic circuit 206 can receive control signal V₂ and constant time signal S_{T} generated by constant time generating circuit 205, and may generate control signal V_{ctrl} to control the switch actions of main power switch device Q₁. In this way, the output voltage and/or output current of the switching regulator can remain substantially constant.

In a particular constant on time example, logic circuit 206 can include RS flip-flop 207, and its set input S can receive control signal V₂, and its reset input R can receive constant time control signal S_{T}. When control signal V₁ is less than compensation signal V_{COMP}, control signal V_{ctrl} can control main power switch device Q₁ to turn on. After a certain constant time period indicated by constant time control signal S_{T} has elapsed, main power switch device Q₁ can be turned off.

The following will describe operating principles of the constant time control circuit by viewing the waveform diagrams of FIGS. 2B and 2C in conjunction the schematic block diagram of FIG. 2A. In FIG. 2B, in a normal operation state, at two time intervals of time t₀ to time t₁, and time t₃ to time t₄, when main power switch device Q₁ is turned on (e.g., when V_{G} is high), inductor current i_{L} and control signal V₁ can continuously rise. After certain or predetermined constant on time t_{ON} has elapsed, main power switch device Q₁ can be turned off (e.g., when V_{G} is low), and inductor current i_{L} and control signal V₁ can continuously fall. When control signal V₁ falls to a level of compensation signal V_{COMP}, main power switch device Q₁ may be turned on again. Repeating this behavior, by the periodic on and off control of the main power switch device, and the periodic rising and falling of inductor current i_{L}, the average value of the inductor current can be controlled. In this way, output current iₒᵤₜ and output voltage Vₒᵤₜ can be maintained as substantially constant.

When the output load “jumps” or undergoes a transient step change (e.g., in FIG. 2B, at time t₂, when the output load changes from a heavy load to a light load), output current iₒᵤₜ may rapidly decline, and output voltage Vₒᵤₜ and control signal V₁ can instantly rise. Because compensation signal V_{COMP} can be substantially constant and control signal V₁ may increase, during time interval from t₂ to t₃, inductor current i_{L} can continuously fall, and thus the inductor current value can be reduced to a lower value. Therefore, within this time interval, output voltage Vₒᵤₜ can generally restore to a level of reference voltage V_{REF1}. When control signal V₁ falls again to a level of compensation signal V_{COMP}, main power switch device Q₁ can be turned on again. Thus, when the load jumps or undergoes a transient step change from high to low, since the average value of the inductor current is substantially at the new low output current level, the output voltage can fall to a new steady state voltage within a relatively short time, thus realizing good transient response.

Referring now to FIG. 2C, shown is a waveform diagram of another example operation of the constant time control circuit shown in FIG. 2A. At time t₅, the output load may rapidly change from a light load to a heavy load, causing output current iₒᵤₜ to jump or step change upwards. The output current can instantly rise, and output voltage Vₒᵤₜ and control signal V₁ can instantly fall. Because compensation signal V_{COMP} can be substantially constant, control signal V₁ can be less than compensation signal V_{COMP}, and main power switch device Q₁ may be turned on, thus causing inductor current i_{L} to increase to time t₆.

In a switching power supply system, a minimum off time (mini_off) can be employed as to main power switch transistor Q₁. The inherent delay that exists in the logic circuit and driving circuit in the power supply system can define this minimum off time. In order to limit the largest duty cycle or on time of main power switch Q₁, the power supply system may also set or predetermine a minimum off time. Therefore, due to the limit of the smallest off time mini_off, at time t₆ to t₇, main power switch device Q₁ may be forcefully turned off, and the duration of the off state can be the minimum off time of the system. Within the minimum off time, inductor current i_{L} can continuously fall.

After the minimum off time ends, because control signal V₁ may still be less than compensation V_{COMP}, main power switch device or transistor Q₁ may be turned on again, and inductor current i_{L} can be restored to the boost or increased state as shown. By the above control solutions, output voltage Vₒᵤₜ can rapidly be restored to a level of reference voltage V_{REF1}, and the average value of the inductor current can be maintained as substantially constant. When there is load jump or step change, since the average value of the inductor current can continuously/rapidly increase, and the output voltage can quickly rise to a steady state voltage, good transient response can be realized.

It can be seen that by using the constant time control circuit of particular embodiments, in a steady state working state, the steady state error of the switching regulator is essentially zero, and via a relatively simple compensation design, the control loops may have sufficient stable allowance as to circuit parameters and/or application conditions. Thus, when there is load step change, the average value of the inductor current may quickly rise or fall such that the output voltage can quickly adjust or be restored to a steady state level to realize good transient response.

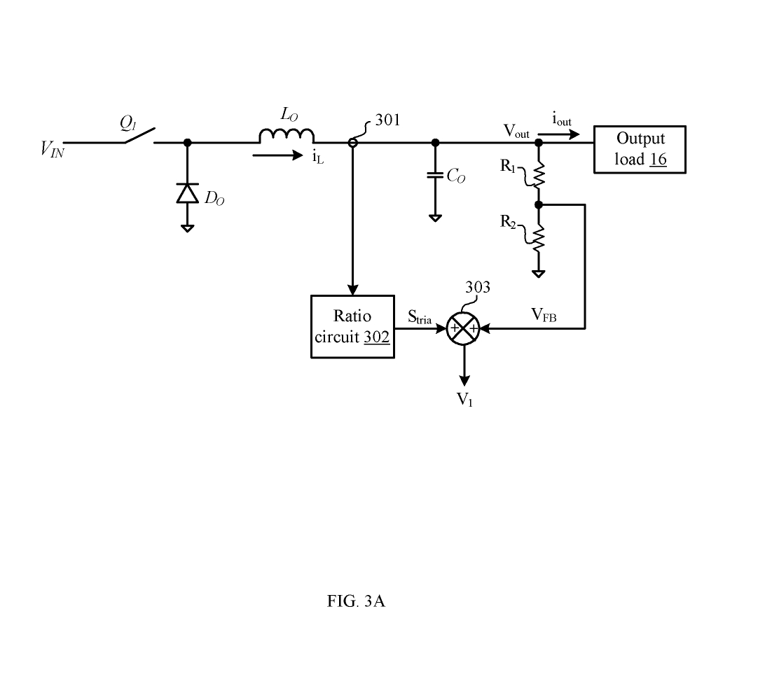

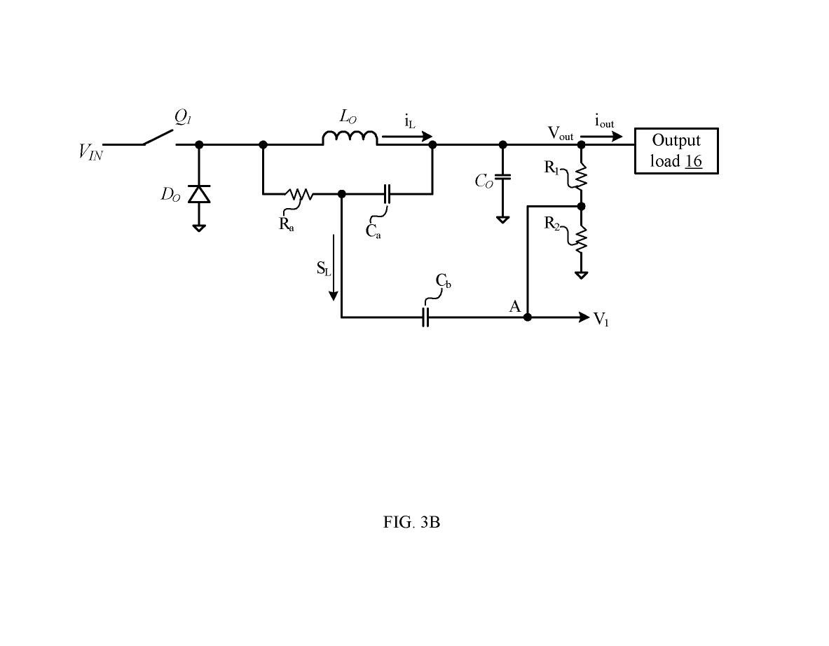

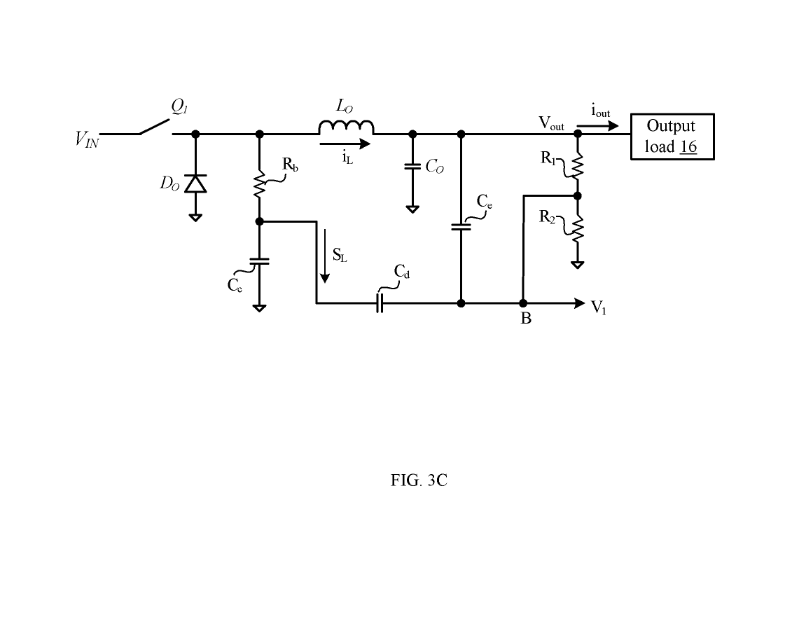

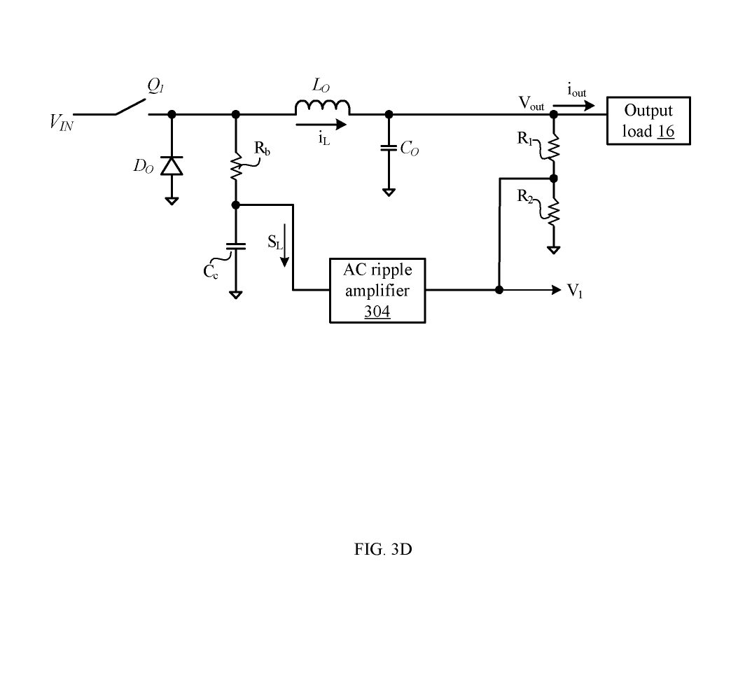

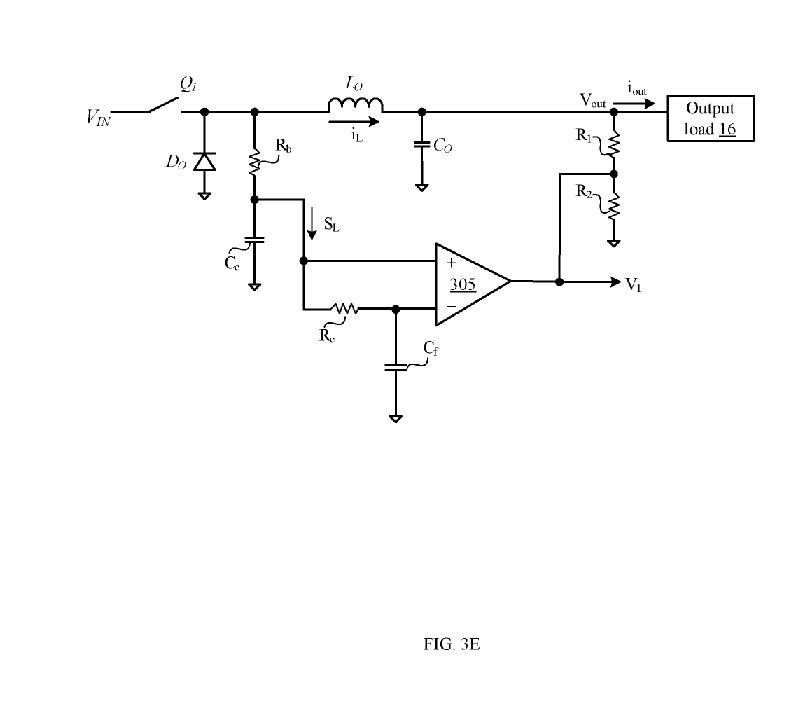

Various triangle wave signal generating circuits can be utilized in a constant time control circuit (e.g., of FIG. 2A) in particular embodiments. Referring now to FIG. 3A, shown is a schematic block diagram of a first example triangle wave signal in accordance with embodiments of the present invention. In this particular example, Hall current sensor 301 can be positioned at a common node of inductor L_{O} and capacitor C_{O}, to sample inductor current Ratio circuit 302 can perform a ratio calculation on inductor current i_{L} to generate triangle wave signal Sₜᵣᵢₐ. After summing circuit 303 performs superimposing of triangle wave signal Sₜᵣᵢₐ and voltage feedback signal V_{FB}, control signal V₁ can be provided. Alternatively, the sampling of the inductor current can be realized by other circuit structures, such as sampling resistors.

Referring now to FIG. 3B, shown is a schematic block diagram of a second example triangle wave signal generating circuit in accordance with embodiments of the present invention. In this particular example, resistor Rₐ and capacitor Cₐ connected in serial at two ends of inductor L_{O} may form a direct current resistance (DCR) detection circuit. The DCR detection circuit can indicate inductor current i_{L} flowing through inductor L_{O}, so as to generate detection signal S_{L} indicating the inductor current information at a common node of resistor Rₐ and capacitor Cₐ. After blocking capacitor C_{b} performs a blocking process, the DC signal portion of detection signal S_{L} can be filtered. The remaining AC signal part of detection signal S_{L} can be superimposed with voltage feedback signal V_{FB} at node A, so as to obtain a more accurate control signal V₁.

Referring now to FIG. 3C, shown is a schematic block diagram of a third example triangle wave signal generating circuit in accordance with embodiments of the present invention. In this particular example, resistor R_{b} and capacitor C_{c} can connect in series between ground and the power stage circuit of inductor L_{O}, and may be used to detect inductor current i_{L} flowing through inductor L_{O}. Detection signal S_{L} indicating the inductor current information can be generated at a common node of resistor R_{b} and capacitor C_{c}. Blocking capacitors C_{d} and Cₑ can be coupled between a common node of resistor R_{b} and capacitor C_{c}, and the output (e.g., at output voltage Vₒᵤₜ) of the power stage circuit. Blocking capacitors C_{d} and Cₑ can receive detection signal S_{L}, and may filter the DC signal portion from detection signal S_{L}. The AC signal portion from detection signal S_{L} can be superimposed with voltage feedback signal V_{FB} at common node B, so as to generate control signal V₁.

Referring now to FIG. 3D, shown is a schematic block diagram of a fourth example triangle wave signal generating circuit in accordance with embodiments of the present invention. Different from the example of FIG. 3C, detection signal S_{L} may pass through an AC ripple amplifier 304 to filter the DC signal portion from detection signal S_{L}. AC ripple amplifier 304 may also amplify the AC signal portion from detection signal S_{L}, which can be superimposed with feedback signal V_{FB} to generate control signal V₁.

Referring now to FIG. 3E, shown as a schematic block diagram of an example AC ripple amplifier of the triangle wave signal generating circuit of FIG. 3D. AC ripple amplifier 304 can include amplifier 305, resistor R_{c}, and capacitor C_{f}. For example, the in-phase input of amplifier 305 can receive detection signal S_{L}, and resistor R_{c} and capacitor C_{f} can be coupled to a common node of resistor R_{b} and capacitor C_{c}. Also, a common node of resistor R_{c} and capacitor C_{f} can connect to the inverted input of amplifier 305. The in-phase input of amplifier 305 can receive detection signal S_{L} that includes both AC and DC signal portions. By the filtering function of resistor R_{c} and capacitor C_{f}, the signal at the inverted input of amplifier 305 can be the DC signal portion of detection signal S_{L}, and the signal at the output of amplifier 305 can be the AC signal portion of detection signal S_{L}.

Those skilled in the art will recognize that the power stage circuit may be of any suitable topology (e.g., buck type, boost type, boost-buck type, isolated topology, etc.). Also, the constant time control circuit can include a constant on time or a constant off time control solution. Further, the constant time generating circuit may be any suitable circuit structure that can generate fixed, or substantially fixed, time for signal generation.

In the particular example constant time control circuit of FIG. 2A, when the output current jumps or undergoes a step change from low to high, due to minimum off time (mini_off) restriction, the inductor current may not continuously increase, potentially influencing transient response. If during the transient response process, the minimum off time is “shielded” or bypassed, the transient response can be further accelerated.

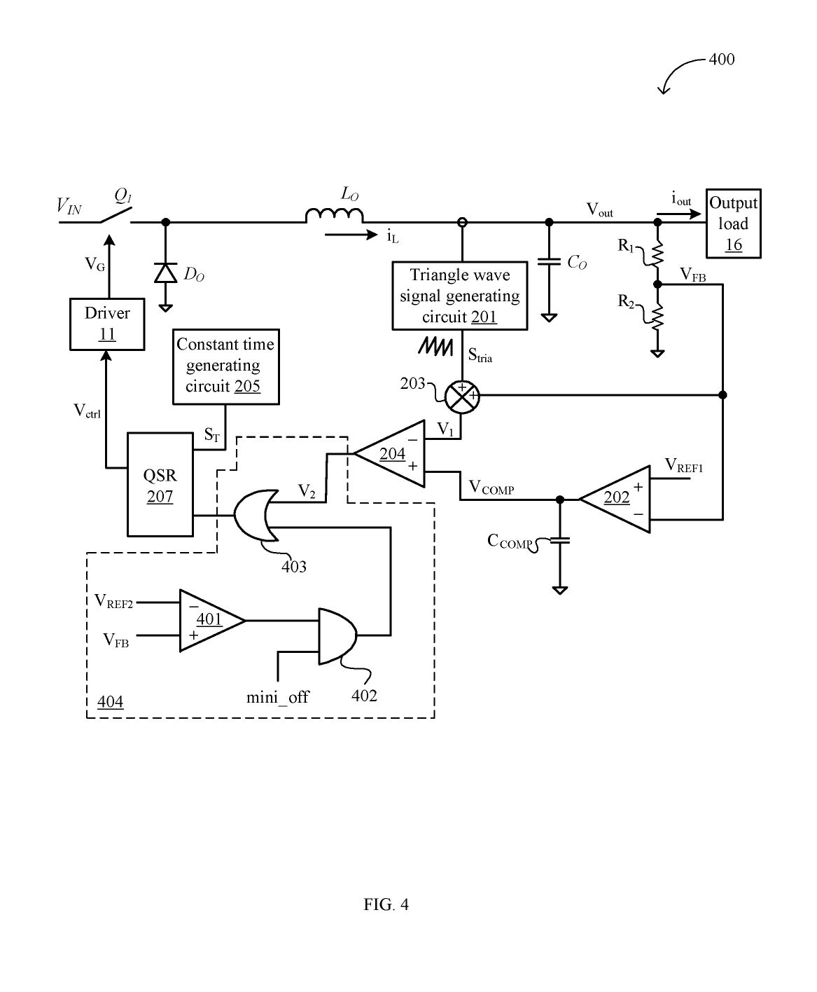

Referring now to FIG. 4, shown is a schematic block diagram of another example constant time control circuit for controlling a switching regulator in accordance with embodiments of the present invention. In this example, constant time control circuit 400 can include shielding circuit 404 to shield the minimum off time during a transient response time, to further reduce the transient response time and improve transit response performance. Specifically, shielding circuit 404 can include comparator 401, AND-gate 402, and OR-gate 403. Comparator 401 can be utilized for comparing voltage feedback signal V_{FB} that indicates current output voltage value(s) against reference voltage V_{REF2}. Here, reference voltage V_{REF2} can be set according to related system parameters, and when the output voltage is greater than reference voltage V_{REF2}, it may be determined that a transient change is occurring.

AND-gate 402 can receive an output from comparator 401 and the minimum off time signal, mini_off. When the output current undergoes a step change from low to high, and voltage feedback signal V_{FB} is less than reference voltage V_{REF2}, the output of comparator 401 can be low, and regardless of the state of mini_off, the output of AND-gate 402 may be low, and thus the minimum off time (mini_off) will essentially be disabled or bypassed. During the time interval from time t₆ to time t₇ (as shown in FIG. 2C), the status of the inductor current i_{L} is generally rising, but decreases due to the minimum off time operation. However, shielding or bypass circuit 404 can allow for the inductor current to again or to continue to increase, such as in some cases after going through a current reduction during this time interval.

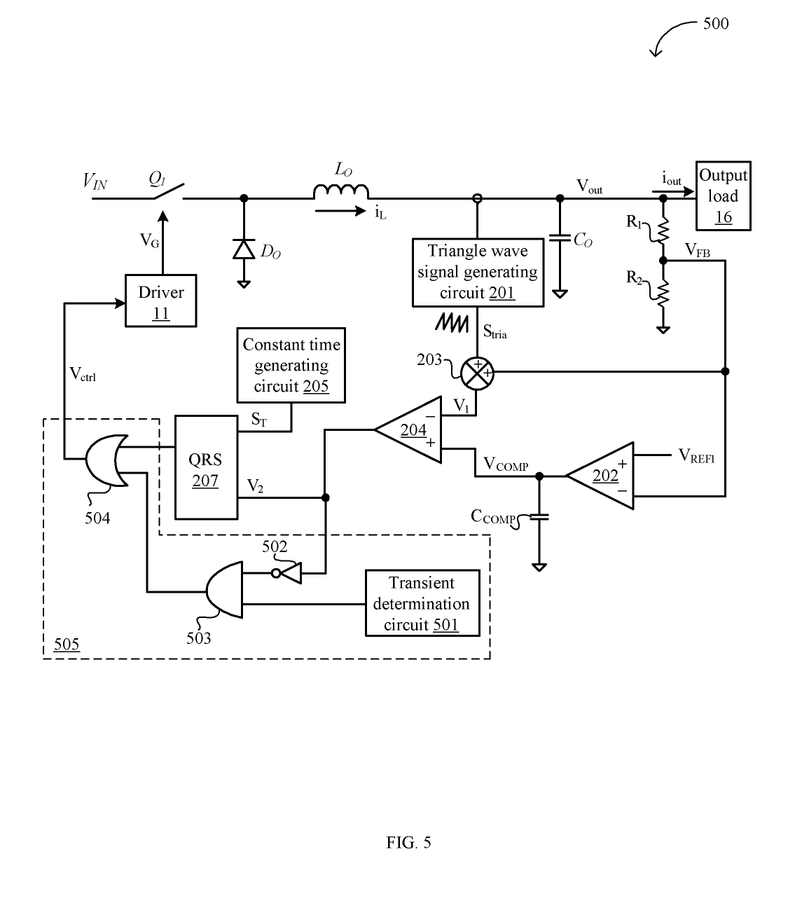

Referring now to FIG. 5, shown is a schematic block diagram of another example constant time control circuit in accordance with embodiments of the present invention. In this particular example, when the output current jumps, constant time control circuit 500 can directly extend the on time of power switch Q₁ for rapid transient response. Specifically, constant time control circuit 500 can increase the on time of power switch Q₁ by utilizing extension time circuit 505. For example, extension time circuit 505 can include transient determination circuit 501, inverter 502, AND-gate 503, and OR-gate 504.

Transient determination circuit 501 can determine occurrence of a transient change based on voltage feedback signal V_{FB} and reference voltage V_{REF1}, such as by different implementation (e.g., a comparator). For example, when the output current jumps from low to high and when voltage feedback signal V_{FB} is less than reference voltage V_{REF1}, and when control signal V₂ goes low, the inputs to AND-gate 503 are both high. Main power switch device Q₁ can be turned on by OR-gate 504, until voltage feedback V_{FB} signal restores to a level of reference voltage V_{REF1}, to accomplish transient response. In this way, during the transient process, the on time of main power switch device Q₁ can be increased or extended.

Those skilled in the art will recognize that that based on the same principles described above, constant time control can also utilize constant off time-based solutions. For example, based on the example shown in FIG. 4, a corresponding shielding/bypass circuit can shield a minimum on time (minion) during the jump from high to low, so as to accomplish rapid transient response. In addition, such circuit operation can occur during, or close to, a transient change time, as opposed to being in a short-circuit, over-current, or start state.

The following will describe another example implementation of improving constant time control circuit transient response by use of a constant time generating circuit.

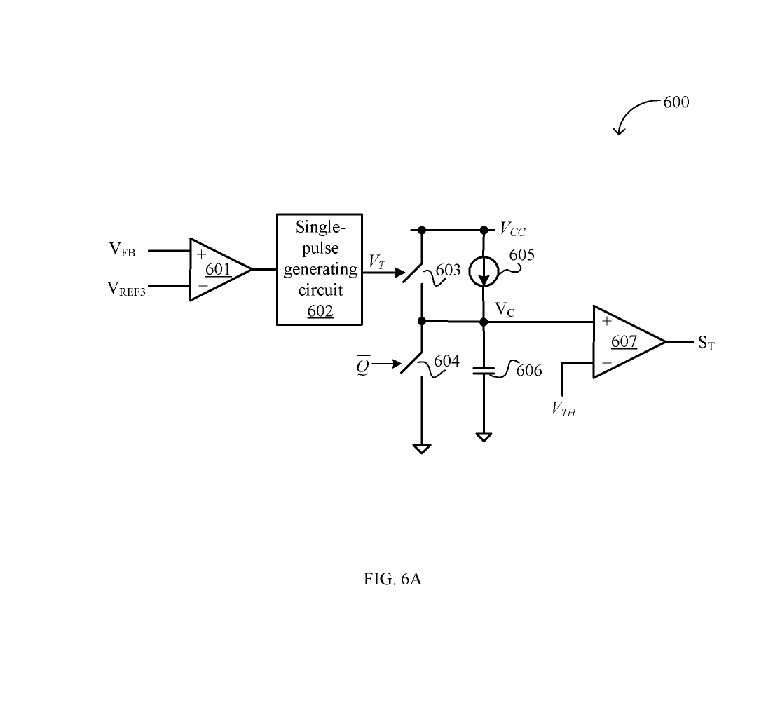

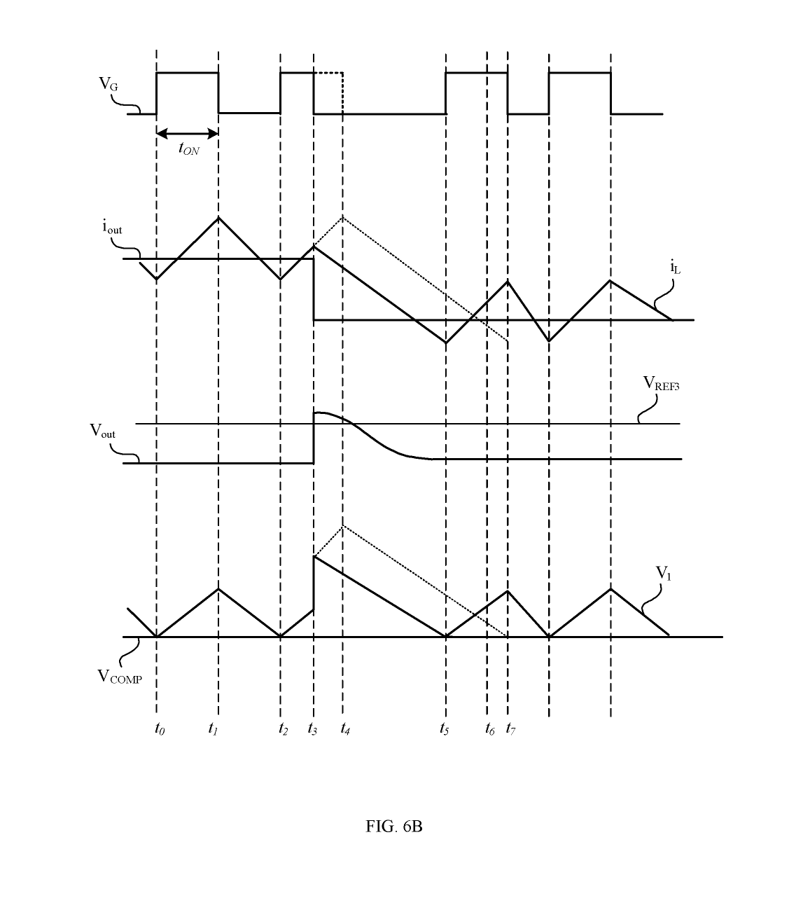

Those skilled in the art will recognize that the constant time generating circuit may be realized by different implementations. Based on the above examples, the example constant time control circuit shown in FIG. 2A may have constant time generating circuit 205 implemented as shown in the example of FIG. 6A. In this particular example of FIG. 6A, constant time generating circuit 600 can include a first transient control circuit of comparator 601, single-pulse generating circuit 602, and switch 603, and switch 603, and a time generating circuit including constant current source 605, capacitor 606, switch 604, and comparator 607.

For example, constant current source 605 and capacitor 606 can connect between voltage source V_{CC} and ground. Switch 604 can connect between a common node and ground between constant current source 605 and capacitor 606. Switch 603 can connect between a common node of voltage source V_{CC} and constant current source 606. The in-phase input comparator 601 can receive voltage feedback signal V_{FB}, and the inverted input end can receive reference voltage V_{REF3}. The output of comparator 601 can connect to the input of single-pulse generating circuit 602. Transient control signal V_{T} output by single-pulse generating circuit 602 can be a single-pulse or one-shot signal used to control the switch status of switch 603. The in-phase input of comparator 607 can connect to a common node of constant current source 605 and capacitor 606 and a common node of switch 604 and switch 603. The inverted input of comparator 607 can connect to voltage threshold value V_{TH}, and the output of comparator 607 can be used as constant time signal S_{T}.

The following will describe example operation by viewing the waveform diagrams of FIG. 6B in conjunction with the example constant time control/generating circuit of FIG. 6A. In a normal operating state, during the time interval from time t₀ to time t₂ shown in FIG. 6B, when the main power switch device is turned on (e.g., V_{G} is high), inductor current i_{L} can continuously rise, compensation signal V_{COMP} can remain substantially constant, and thus control signal V₁ can continuously rise.

At this time, switch 604 may be off, constant current source 605 can continue to charge capacitor 606, and voltage V_{C} can continuously rise. After certain on time t_{ON} has elapsed, voltage V_{C} can rise to a level of voltage threshold value V_{TH}. The output of comparator 607 can then go high, and thus main power switch Q₁ can be turned off. Switch 604 can be closed, and the voltage on capacitor 606 may be rapidly discharged. Also, inductor current i_{L} and control signal V₁ may continuously fall. When control signal V₁ decreases to a level of compensation signal V_{COMP}, main power switch Q₁ can be turned on again. This operation can repeat, and the average value of the inductor current i_{L}, which is output current iₒᵤₜ, can be maintained as substantially constant, along with output voltage Vₒᵤₜ.

Within the on time of the main power switch device, e.g., time t₃ in FIG. 6B, output current iₒᵤₜ jumps from high to low, and the output voltage instantly rises, which also makes control signal V₁ instantly rise. At this time, since output voltage Vₒᵤₜ has gone above the value of reference voltage V_{REF3}, the output of comparator 601 can go high to trigger single-pulse generating circuit 602. Transient control signal V_{T} can control switch 603 to close, and voltage V_{C} at the common node of constant current 605 and capacitor 606 can instantly rise. Since voltage V_{C} is higher than voltage threshold V_{TH}, the output of comparator 607 can go high, and the main power switch device can be turned off in advance, rather than at the constant on time.

Therefore, inductor current i_{L} can continuously fall from time t₃, and control signal V₁ can continuously decrease until time t₅. At this time, output voltage Vₒᵤₜ may also restore to a level of reference voltage V_{REF1}. When control signal V₁ again decreases to a level of compensation signal V_{COMP}, main power switch device Q₁ can be turned on again. From time t₅, the circuit can be restored to a stable state. As compared with a control solution that does not reduce the on time, when the jump occurs at time t₃, since main power switch Q₁ may still be on, inductor current i_{L} and control signal V₁ may still rise until the on time is over at time t₄. Because control signal V₁ has a higher value in this case, it needs a longer time, e.g., to time t₇, to fall to compensation signal V_{COMP}, thus increasing the transient response time.

In this example, reference voltage V_{REF3} can be set according to system references, and/or parameters. When the output voltage is greater than reference voltage V_{REF3}, it occurrences of a transient change can be determined. Also, voltage threshold V_{TH} can be sent or determined based on various system parameters (e.g., constant time width). In the constant time control circuit shown in FIG. 6A, when the transient state changes, the pulse currently with the constant time width may be turned off in advance, in order to ensure that the change tendency of inductor current i_{L} follows the change tendency iₒᵤₜ of the output current. This can reduce the difference between i_{L} and iₒᵤₜ, thus realizing rapid or real-time response to the transient state change. Also, output voltage fluctuation can be reduced in order to reduce associated recovery time of the output voltage.

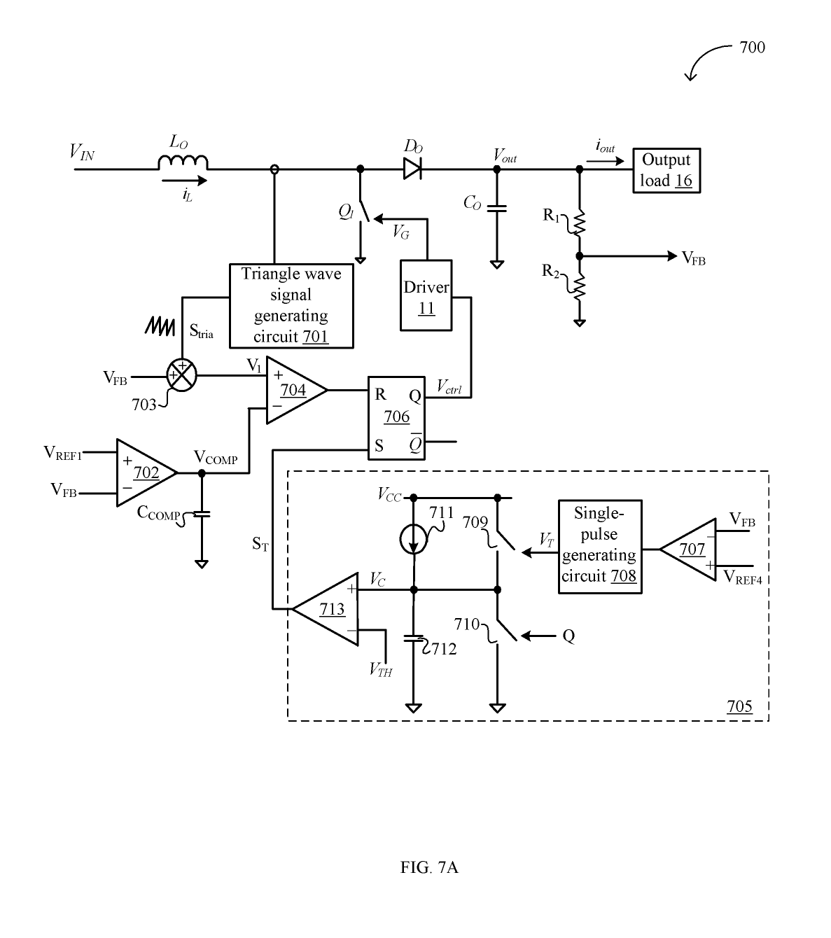

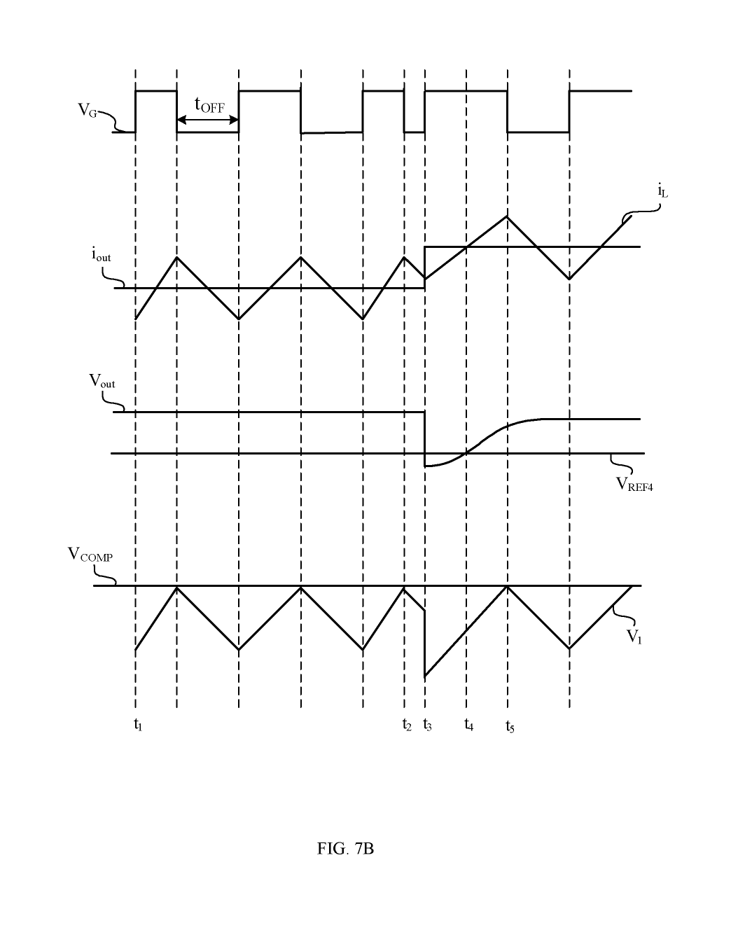

In addition to constant on time solutions, particular embodiments are also applicable to constant off time control circuits, as will be discussed in more detail below. Referring now to FIG. 7A, shown is a schematic block diagram of an example constant time control circuit in accordance with embodiments of the present invention. In addition, FIG. 7B is a waveform diagram showing an example operation of the constant time control circuit shown in FIG. 7A. In this example, the power stage circuit of the switching regulator is of a boost mode topology; however, other regulator topologies can also be employed in particular embodiments.

Triangle wave signal generating circuit 701 can generate triangle wave signal Sₜᵣᵢₐ based on the inductor current i_{L}. Triangle wave signal Sₜᵣᵢₐ and voltage feedback signal V_{FB} indicating the output voltage can be summed by summing circuit 703 to generate control signal V₁. Low bandwidth amplifier 702 can calculate an error between voltage feedback signal V_{FB} and reference voltage V_{REF1}, and after being compensated by capacitor C_{COMP}, compensation signal V_{COMP} (e.g., a substantially constant level) can be obtained.

Comparator 704 can compare control signal V₁ against compensation signal V_{COMP}. When control signal V₁ is greater than compensation signal V_{COMP}, main power switch device Q₁ can be turned off by RS flip-flop 706 and driver 11. Constant time generating circuit 705 may be utilised for generating a constant time control signal S_{T}. After the main power switch device is off for the duration of constant time t_{OFF}, main power switch device Q₁ can be turned on. This can repeat, and the main power switch device can be periodically turned on and off, in order to maintain the output voltage and/or the output current as substantially constant.

For example, constant time generating circuit 705 can include a second transient control circuit including comparator 707, single-pulse generating circuit 708, and switch 709, switches 709 and 710 connected in series between voltage source V_{CC} and ground, and constant current source 711 and capacitor 712 coupled in series between voltage source V_{CC} and ground. Voltage V_{C} at a common node of switches 709 and 710 and at a common node of constant current source 711 and capacitor 712 can be provided to the in-phase input of comparator 713, and the inverted input can receive voltage threshold V_{TH}, and the output of comparator 713 can be used as constant time signal S_{T}.

From time t₁ to time t₂, the system may be operable in a stable operating state. During the off time of the main power switch device (e.g., at time t₃), the output current can jump or undergo a step change from low to high. If the fixed off time t_{OFF} is maintained to time t₃, the inductor current can continuously fall until time t₃. Meanwhile, the output voltage may fall instantly, causing control signal V₁ to also instantly fall. The main power switch device can be turned on when the off time is over, and then inductor current i_{L} and control signal V₁ can rise.

In this example, at time t₃, when it is detected that voltage feedback signal V_{FB} is less than reference voltage V_{REF4}, the output of comparator 707 can go high, and single-pulse generating circuit 708 can be triggered to close switch 709. At this time, switch 710 may be off, and voltage V_{C} can become instantly higher, and its value can exceed voltage threshold V_{TH}. The output of comparator 713 can go high, so as to set RS flip-flop 706 to turn on the main power switch device. Then, inductor current i_{L} and control signal V₁ can continuously, and output voltage Vₒᵤₜ may be restored to a level of reference voltage V_{REF1}. Until time t₅, control signal V₁ can rise to a level of compensation signal V_{COMP}, and the main power switch device can be turned off again. The off state duration time can be constant time t_{OFF}, and the system can be restored to a stable state.

In this example, reference voltage V_{REF4} can be based on related system parameters. When the output voltage is less than reference voltage V_{REF4}, occurrence of a transient change (e.g., a step change or jump) can be determined. Voltage threshold value V_{TH} can also be set based on related system parameters (e.g., constant time width, etc.). For the same reason, when the transient change occurs, by turning off the constant time signal currently having a constant time width, inductor current i_{L} can follow the output current, and rapid or real-time response to the transient change can be realized. Also, ripple of the output voltage can be reduced such that output voltage recovery time can be reduced.

In one embodiment, a method of controlling a switching regulator can include: (i) obtaining a voltage feedback signal by detecting an output voltage of the switching regulator; (ii) generating a triangle wave signal by detecting a current flowing through an inductor of the switching regulator; (iii) generating a first control signal by superimposing the triangle wave signal and the voltage feedback signal; (iv) calculating an error between the voltage feedback signal and a first reference voltage, and compensating for the error to obtain a compensation signal, where the compensation signal is maintained as substantially constant; (v) generating a second control signal by comparing the first control signal against the compensation signal; (vi) controlling switching of a power switch in the switching regulator based on the second control signal and a constant time control signal, where an output signal of the switching regulator is maintained as substantially constant; and (vii) controlling the inductor current to follow an output current of the switching regulator in response to a step change in the output current, where an average value of the inductor current is restored after the step change to be consistent with the output current to reduce ripples in the output voltage.

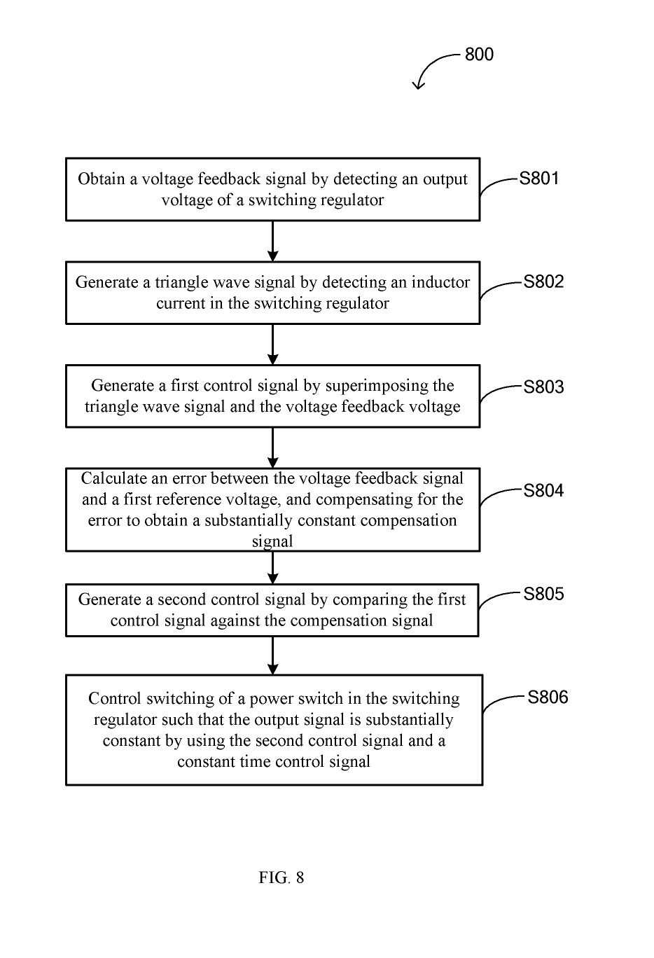

Referring now to FIG. 8, shown is a flow diagram of an example constant time control method 800, in accordance with embodiments of the present invention. At S801, a voltage feedback signal (e.g., V_{FB}) can be obtained by detecting the output voltage of the switching regulator. Thus, the voltage feedback signal can denote or indicate the output voltage. At S802, a triangle wave signal can be generated by detecting current through an inductor in the switching regulator.

At S803, a first control signal (e.g., V₁) can be generated by adding the triangle wave signal and the voltage feedback signal. At S804, an error between the voltage feedback signal and a reference voltage (e.g., V_{REF1}) can be calculated. Also, the error can be compensated for to obtain a substantially constant compensation signal (e.g., V_{COMP}). At S805, the first control signal can be compared against the compensation signal to generate a second control signal (e.g., V₂). At S806, switching of a power switch (e.g., Q₁) in the switching regulator can be controlled such that the output signal of the regulator is substantially constant. This control can utilize the second control signal in a constant time control signal (e.g., S_{T}).

In particular embodiments, different circuit parameters and usage conditions can be considered (e.g., for setting the reference voltages, threshold voltages, etc.), and by using relatively simple compensation circuit design (e.g., an integrator) good compensation and stable margins can be realized. In addition, when the output current jumps (undergoes a step change), the inductor current can continuously and rapidly follow the change of the output current, so that the average value of the inductor current can be restored to be consistent with the output current. Further, the ripple of the output voltage from the step change can be reduced.

In particular embodiments, during each switch period, the second control signal can be used for controlling the on time of the power switch device. Also, the constant time control signal can be used for controlling the on time of the power switch device as a constant time. When the output current jumps from low to high, the minimum off time of the switching regulator can be shielded or bypassed. When the output current jumps from low to high, after certain constant time, the on time of the power switch device can be extended.

Within the on time of the power switch device, when the output current jumps from high to low, the constant time control signal can be turned on in advance to reduce the on time of the power switch device. For example, during each switch cycle, the second control signal may be used for controlling the off time of the power switch device, and the constant time control signal may be used for controlling the off time of the power switch device as a constant time. When the output current jumps from high to low, the minimum on time of the switching regulator can be shielded or bypassed. When the output current jumps from high to low, after the constant time, the off time of the power switch device may be extended. When within the off time of the power switch device, when the output current jumps from low to high, the constant time control signal can be turned off in advance to reduce the off time of the power switch device.

In this way, when the output current jumps, the inductor current can follow the change of the output current to the maximum extent, and the difference between the inductor current in the output current can be reduced to the maximum extent, thus rapid or real-time response to the transient change can be realized. In addition, the fluctuation of the output voltage may be reduced, so that the recovery time of the output voltage can be reduced.

Generating a triangle wave signal can be realized by different implementations. For example, the inductor current flowing through the inductor of the switching regulator can be sampled, and a ratio calculation can be performed to the inductor current to get the triangle wave signal. In another example, a DCR detecting approach can be used to detect the inductor current flowing through the inductor of the switching regulator, to get an inductor current signal, and blocking the inductor current signal to get the triangle wave signal. For example, the blocking process can use a blocking capacitor to receive the inductor current signal, and remove the DC portion from the inductor current signal. Alternatively an AC ripple amplifier can receive the inductor current signal, the DC portion from the inductor current signal, and perform an amplification calculation to the AC portion of the inductor current signal.

As shown in FIGS. 2A, 6A, and 7A, a switching regulator of particular embodiments can include any of the above constant time control circuit, as well as a driving circuit. For example, the driving circuit can drive the power switch device in the power stage circuit by using driving signal V_{G} generated based on control signal V_{ctrl}. Moreover, the power stage circuit can be of any suitable topology (e.g., buck type, boost type, boost-buck type, isolated topology, etc.).

The embodiments were chosen and described in order to best explain the principles of the invention and its practical applications, to thereby enable others skilled in the art to best utilize the invention and various embodiments with modifications as are suited to the particular use contemplated. It is intended that the scope of the invention be defined by the claims appended hereto and their equivalents.

What is claimed is:

1. A method of controlling a switching regulator, the method comprising:
a) obtaining a voltage feedback signal by detecting an output voltage of said switching regulator;
b) generating a triangle wave signal by detecting a current flowing through an inductor of said switching regulator;
c) generating a first control signal by superimposing said triangle wave signal and said voltage feedback signal;
d) calculating an error between said voltage feedback signal and a first reference voltage, and compensating for said error to obtain a compensation signal, wherein said compensation signal is maintained as substantially constant;
e) generating a second control signal by comparing said first control signal against said compensation signal;
f) controlling switching of a power switch in said switching regulator based on said second control signal and a constant time control signal, wherein an output signal of said switching regulator is maintained as substantially constant; and
g) controlling said inductor current to follow an output current of said switching regulator in response to a step change in said output current, wherein an average value of said inductor current is restored after said step change to be consistent with said output current to reduce ripples in said output voltage.

2. The method of claim 1, wherein during each switch period:
a) said second control signal is used for controlling an on time of said power switch; and
b) said constant time control signal is used for controlling said on time as a constant time.

3. The method of claim 2, further comprising shielding a minimum off time of said switching regulator when said step change is from low to high.

4. The method of claim 2, further comprising extending said on time after said constant time has elapsed when said step change is from low to high.

5. The method of claim 2, wherein within the on time of said power switch device, when the output current jumps from high to low, turning off said constant time control signal and reducing the on time of said power switch device.

6. The method of claim 1, wherein during each switch period:
a) said second control signal is used for controlling an off time of said power switch; and
b) said constant time control signal is used for controlling said off time as a constant time.

7. The method of claim 6, further comprising shielding a minimum on time of said switching regulator when said step change is from high to low.

8. The method of claim 6, further comprising extending said off time after said constant time has elapsed when said step change is from high to low.

9. The method of claim 1, wherein said generating said triangle wave signal comprises:
a) sampling said inductor current; and
b) performing a ratio calculation on said inductor current to obtain said triangle wave signal.

10. The method of claim 1, wherein said generating said triangle wave signal comprises:
a) detecting said inductor current by a direct current resistance (DCR) circuit to obtain an inductor current signal; and
b) blocking said inductor current signal to obtain said triangle wave signal.

11. The method of claim 10, wherein said blocking said inductor current comprises removing a DC portion of said inductor current signal by a blocking inductor.

12. The method of claim 10, wherein said blocking said inductor current comprises amplifying an AC portion of said inductor current signal by an AC ripple amplifier.

13. A constant time control circuit, comprising:
a) a triangle wave signal generating circuit configured to generate a triangle signal that indicates a current flowing through an inductor of a switching regulator;
b) a first control signal generating circuit configured to generate a first control signal by superimposing said triangle wave signal and a voltage feedback signal that indicates an output voltage of said switching regulator;
c) a compensation signal generating circuit configured to generate a substantially constant compensation signal to compensate for an error between said voltage feedback signal and a first reference voltage;
d) a comparing circuit configured to compare said compensation signal and said first control signal, and to generate a second control signal;
e) a logic circuit configured to generate a third control signal based on said second control signal and a constant time control signal, wherein during each switch cycle of said switching regulator, said third control signal is configured to control an on time or off time of a power switch as a constant time; and
f) wherein said inductor current is controlled to follow an output current of said switching regulator in response to a step change in said output current, wherein an average value of said inductor current is restored after said step change to be consistent with said output current to reduce ripples in said output voltage.

14. The constant time control circuit of claim 13, further comprising a shielding circuit configured to shield a minimum off time of said switching regulator when said step change is from low to high and said on time of said power switch is said constant time.

15. The constant time control circuit of claim 13, wherein said triangle wave signal generating circuit comprises:
a) an inductor current sampling circuit configured to sample said inductor current; and
b) a scaling circuit configured to perform a ratio calculation on said inductor current to generate said triangle wave signal.

16. The constant time control circuit of claim 13, wherein said triangle wave signal generating circuit comprises:
a) a direct current resistance (DCR) current detection circuit configured to detect said inductor current; and
b) a blocking circuit configured to block said inductor current to generate said triangle wave signal.

17. The constant time control circuit of claim 16, wherein said blocking circuit comprises a blocking capacitor.

18. The constant time control circuit of claim 16, wherein said blocking circuit comprises an AC ripple amplifier configured to remove a DC portion of said inductor current signal, and to amplify an AC portion of said inductor current signal.

19. A switching regulator, comprising:
a) a power stage circuit comprising said power switch configured to receive an input voltage;
b) the constant time control of claim 13 coupled to said power stage circuit, wherein said constant time control circuit is configured to generate a square wave control signal; and
c) a driving circuit configured to generate a driving signal in response to said square wave control signal, and to drive said power switch such that an output of said power stage circuit is substantially constant.

20. The switching regulator of claim 19, wherein said power stage circuit comprises a converter topology selected from: buck, boost, buck-boost, and isolated.
